(19) United States
(12) Patent Application Publication
(10) Pub. No.: US 2012/0139482 A1
(43) Pub. Date: Jun. 7, 2012

(54) BATTERY CHARGING MANAGEMENT

(75) Inventors: Tao ZHANG, Shanghai (CN); Wei ZHANG, Shanghai (CN)

(73) Assignee: O2MICRO, INC., Santa Clara, CA (US)

(21) Appl. No.: 13/371,086

(22) Filed: Feb. 10, 2012

(30) Foreign Application Priority Data
Feb. 25, 2011 (CN) 201110051408.8

(51) Int. Cl. H02J 7/00

(52) U.S. Cl. 320/107; 320/150; 320/153

(57) ABSTRACT

A battery charging management apparatus includes an information obtaining unit and a controlling unit coupled to the information obtaining unit. The information obtaining unit obtains parameter information for temperature of a battery during a charging process performed by a charger for the battery. The controlling unit controls the charger to charge the battery based on the parameter information of the battery, so that operation of the charger conforms to a charging rule corresponding to the charging process. The controlling unit decreases a charging signal of the charger by a predetermined decrement if the temperature of the battery increases by a predefined increment.

### RELATED APPLICATION

The present application claims priority to Patent Application No. 201110051408.8, filed on Feb. 25, 2011, with the State Intellectual Property Office of the People's Republic of China.

### BACKGROUND

Batteries are widely used as power sources in applications such as electric or hybrid vehicles, electric bicycles, and electric tricycles. Since the body and accessories of an electric vehicle are relatively heavy, a battery with relatively large charge-capacity is required to supply sufficient energy to the electric vehicle, such that the electric vehicle can run sufficient mileage. A conventional power supply system in the electric vehicle includes a battery, a charger, and a controller. The battery powers various devices in the electric vehicle. The charger charges the battery. The controller is powered by the battery and drives operations of a motor and other devices. Since the battery of the electric vehicle has a relatively high voltage and a large capacity, the battery has a large number of serial-coupled battery cells. A conventional method uses a battery management system to manage the battery. The battery management system monitors status of the charger and the battery, and controls operation of the charger.

When the charger charges the battery using the conventional method, if the temperature of the battery increases, the internal resistance of the battery decreases. Accordingly, the output current of the charger increases, which further decreases the internal resistance of the battery. This cumulative effect can cause thermal runaway phenomena in the battery, which may damage the battery.

### SUMMARY

In one embodiment, a battery charging management apparatus includes an information obtaining unit and a controlling unit coupled to the information obtaining unit. The information obtaining unit obtains parameter information for temperature of a battery during a charging process performed by a charger for the battery. The controlling unit controls the charger to charge the battery based on the parameter information of the battery, so that operation of the charger conforms to a charging rule corresponding to the charging process. The controlling unit decreases a charging signal of the charger by a predetermined decrement if the temperature of the battery increases by a predefined increment.

### BRIEF DESCRIPTION OF THE DRAWINGS

Features and advantages of embodiments of the claimed subject matter will become apparent as the following detailed description proceeds, and upon reference to the drawings, wherein like numerals depict like parts, and in which:

FIG. 1 illustrates a flowchart of an example of a method for managing charging of a battery based on parameter information of the battery, in accordance with one embodiment of the present invention.

FIG. 2 illustrates a flowchart of an example of a method for managing charging of a battery, in accordance with a first embodiment of the present invention.

FIG. 3A illustrates an example of a relationship between temperature of a battery and a charging voltage of a charger, in accordance with the first embodiment of the present invention.

FIG. 3B illustrates an example of a relationship between temperature of a battery and a charging current of a charger, in accordance with the first embodiment of the present invention.

FIG. 3C illustrates an example of a relationship between temperature of a battery and a charging voltage of a charger, associated with an over-temperature charging protection process, in accordance with the first embodiment of the present invention.

FIG. 4 illustrates a flowchart of an example of a method for managing charging of a battery based on charging information of a charger, in accordance with one embodiment of the present invention.

FIG. 5 illustrates a flowchart of an example of a method for managing charging of a battery, in accordance with a second embodiment of the present invention.

FIG. 6 illustrates an example of a relationship between an output current of a charger and a charging voltage of the charger, in accordance with the second embodiment of the present invention.

FIG. 7 illustrates a flowchart of an example of a method for managing charging of a battery based on the amount of charge stored in the battery, in accordance with a third embodiment of the present invention.

FIG. 8 illustrates an example of a relationship between a charging time, an output current of a charger, and an output voltage of the charger, in accordance with the third embodiment of the present invention.

FIG. 9 illustrates a flowchart of an example of a method for managing charging of a battery, in accordance with one embodiment of the present invention.

FIG. 10 illustrates a block diagram of an example of a battery charging management apparatus, in accordance with one embodiment of the present invention.

FIG. 11 illustrates a block diagram of an example of a charger, in accordance with one embodiment of the present invention.

FIG. 12 illustrates a block diagram of an example of a battery management system with a charger, in accordance with one embodiment of the present invention.

### DETAILED DESCRIPTION

Reference will now be made in detail to the embodiments of the present invention. While the invention will be described in conjunction with these embodiments, it will be understood that they are not intended to limit the invention to these embodiments. On the contrary, the invention is intended to cover alternatives, modifications and equivalents, which may be included within the spirit and scope of the invention as defined by the appended claims.

Furthermore, in the following detailed description of the present invention, numerous specific details are set forth in order to provide a thorough understanding of the present invention. However, it will be recognized by one of ordinary skill in the art that the present invention may be practiced without these specific details. In other instances, well known methods, procedures, components, and circuits have not been described in detail as not to unnecessarily obscure aspects of the present invention.

Embodiments of the present invention provide a method and apparatus for managing charging of a battery, and also provide a charger and a battery management system that include the apparatus. Using the method, apparatus, charger, and/or system of the present invention can avoid thermal runaway phenomena during a charging process of the battery, thereby extending the life of the battery.

In one embodiment, the charging process includes a pre-charging stage, a constant-current charging stage, a constant-voltage charging stage, and a floating charging stage. Accordingly, a charging rule corresponding to the charging process includes: during the pre-charging stage, the voltage of the battery is relatively low, the output current of the charger is relatively small, and the output voltage of the charger increases gradually; during the constant-current charging stage, the output current of the charger remains substantially constant, and the output voltage of the charger increases gradually; during the constant-voltage charging stage, the output voltage of the charger remains substantially constant, and the output current of the charger decreases gradually; and during the floating charging stage, the output voltage of the charger remains substantially constant, the output current of the charger is relative small, and a charging voltage, e.g., a preset output voltage, of the charger in the floating charging stage is less than that in the constant-voltage charging stage. The charger performs the charging process in the floating charging stage to compensate the lost energy due to self-discharging of the battery.

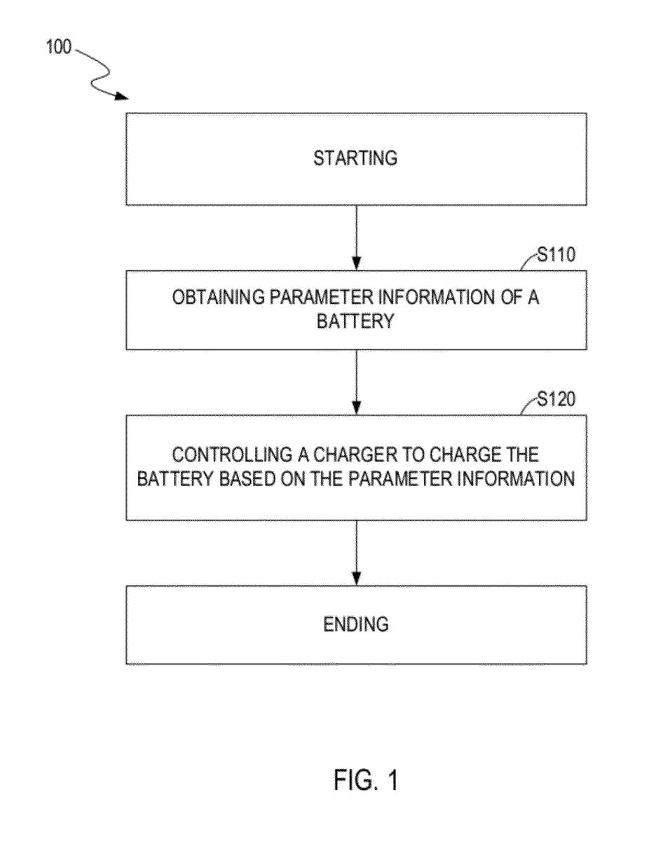

FIG. 1 illustrates a flowchart of an example of a method for managing charging of a battery based on parameter information of the battery, e.g., temperature of the battery, in accordance with one embodiment of the present invention. Although specific steps are disclosed in FIG. 1, such steps are examples. That is, the present invention is well suited to perform various other steps or variations of the steps recited in FIG. 1. In one embodiment, the battery can be, but is not limited to, a lithium-ion battery, a lead-acid battery, or the like.

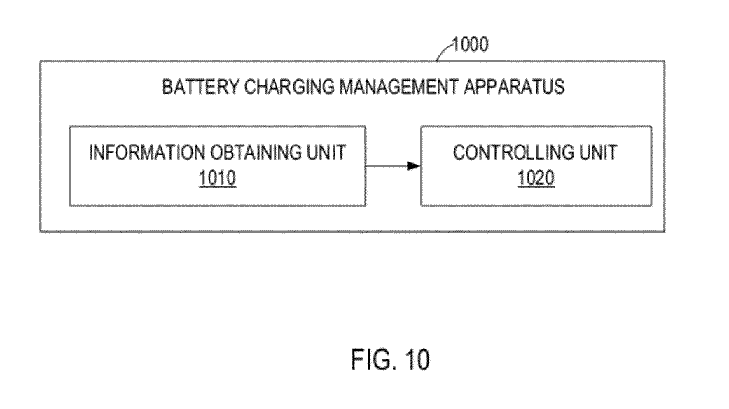

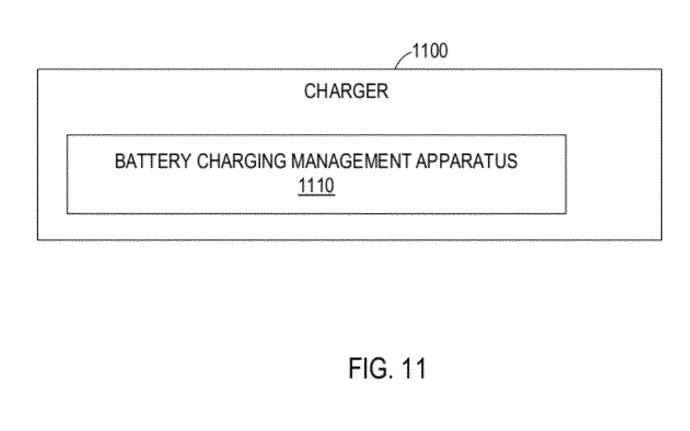

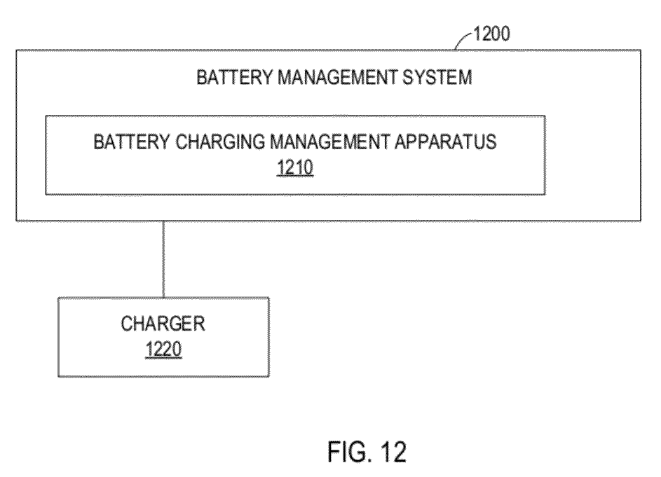

In step S110, during a charging process performed by a charger (e.g., the charger 1100 in FIG. 11, the charger 1220 in FIG. 12) for the battery, parameter information of the battery is obtained. The parameter information of the battery can be read or measured by the charger or a battery management system (e.g., the battery management system 1200 in FIG. 12), so that a battery charging management apparatus (e.g., the apparatus 1000 in FIG. 10, the apparatus 1110 in FIG. 11, or the apparatus 1210 in FIG. 12) can obtain the parameter information from the charger or the battery management system.

In step S120, the battery charging management apparatus controls the charger to charge the battery based on the parameter information of the battery, so that operation of the charger conforms to a charging rule corresponding to the charging process.

Advantageously, according to the method for managing charging of the battery in one such embodiment, the battery charging management apparatus controls the charger to charge the battery based on the parameter information of the battery, so that the operation of the charger conforms to the charging rule corresponding to the charging process. The method can avoid an abnormal increase of the temperature of the battery that is caused by anomalies produced during the charging process, then avoid thermal runway phenomena in the battery, thereby extending the life of the battery.

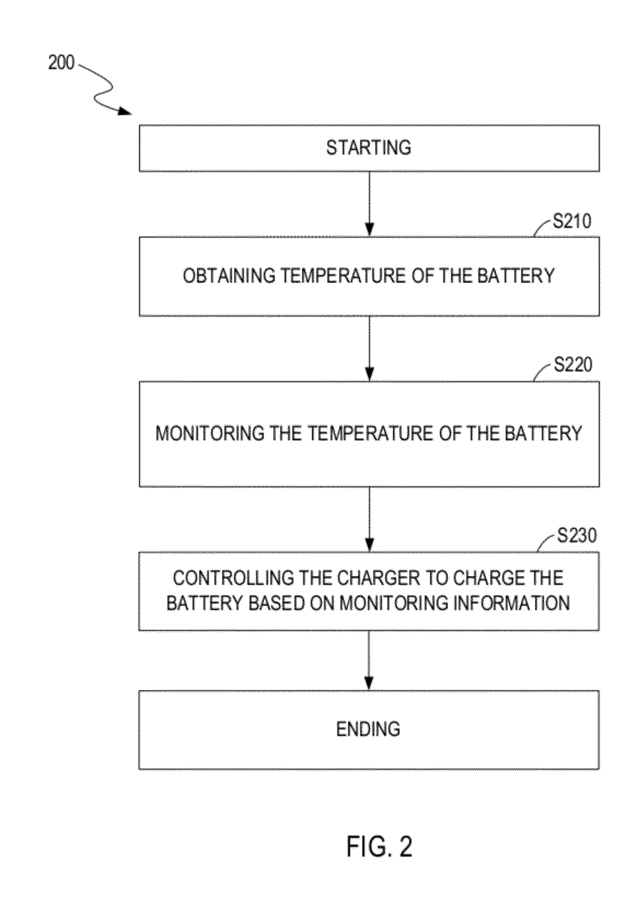

FIG. 2 illustrates a flowchart of an example of a method for managing charging of a battery, in accordance with a first embodiment of the present invention. Although specific steps are disclosed in FIG. 2, such steps are examples. That is, the present invention is well suited to perform various other steps or variations of the steps recited in FIG. 2. In one embodiment, since the temperature of the battery is one of the main reasons that cause thermal runway phenomena in the battery, the parameter information of the battery includes the temperature of the battery.

In step S210, the temperature of the battery is obtained during the charging process. The temperature of the battery can be measured by the charger or the battery management system. In step S220, the battery charging management apparatus monitors the temperature of the battery to obtain monitoring information. In step S230, the battery charging management apparatus controls the charger to charge the battery based on the monitoring information, so that the operation of the charger conforms to the charging rule corresponding to the charging process.

If the monitoring information indicates that the temperature of the battery is less than a predetermined maximum charging temperature of the battery, the battery charging management apparatus adjusts at least one of a charging voltage, e.g., a preset output voltage, of the charger and a charging current, e.g., a preset output current, of the charger based on the temperature of the battery.

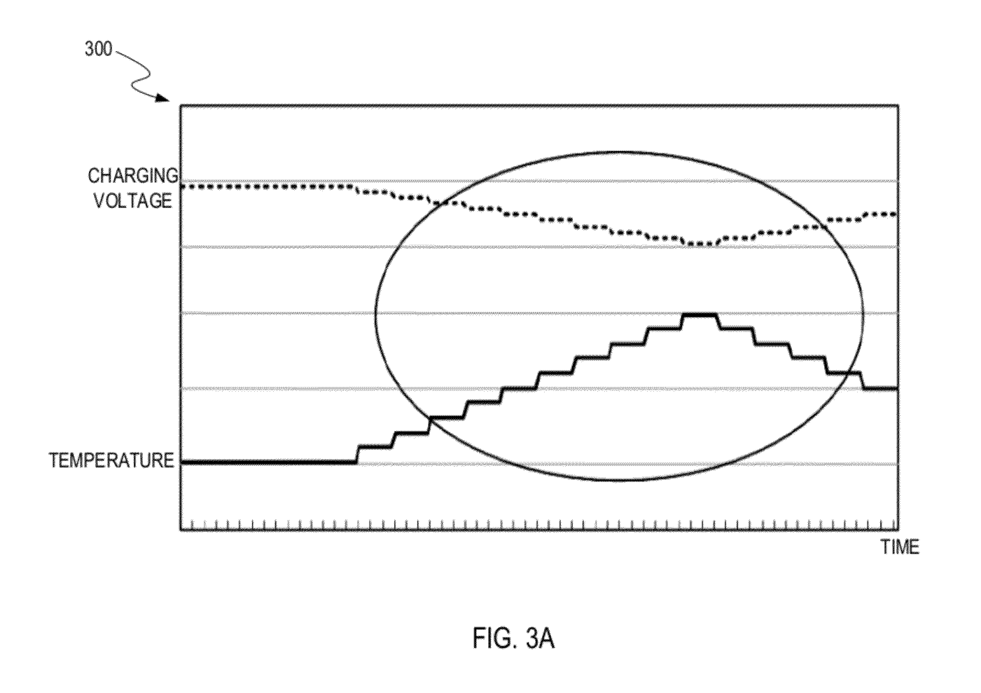

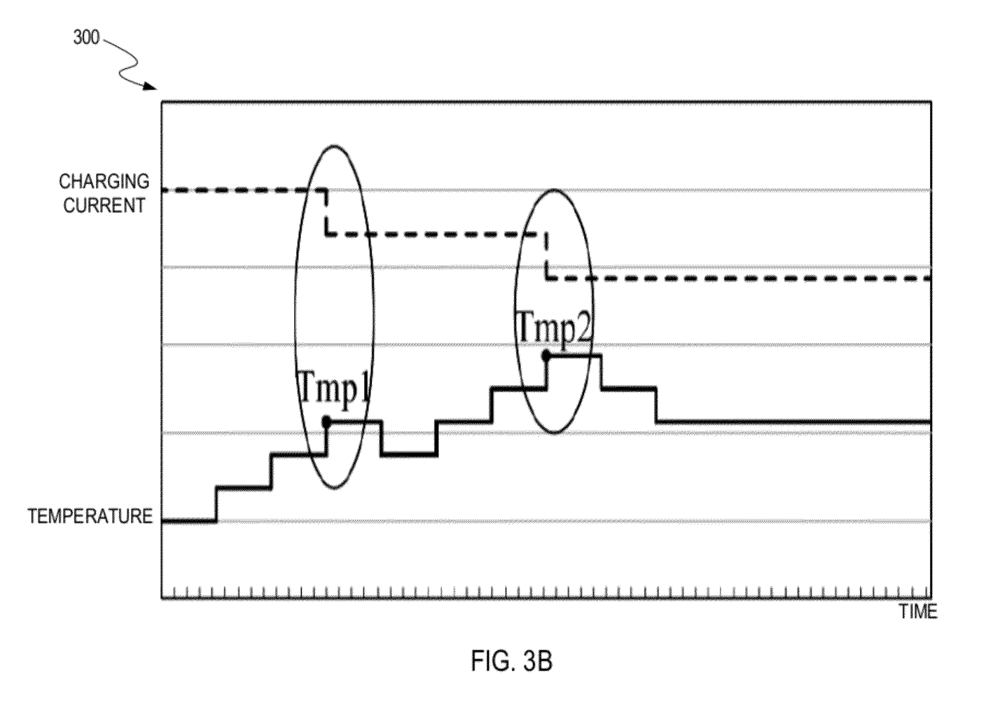

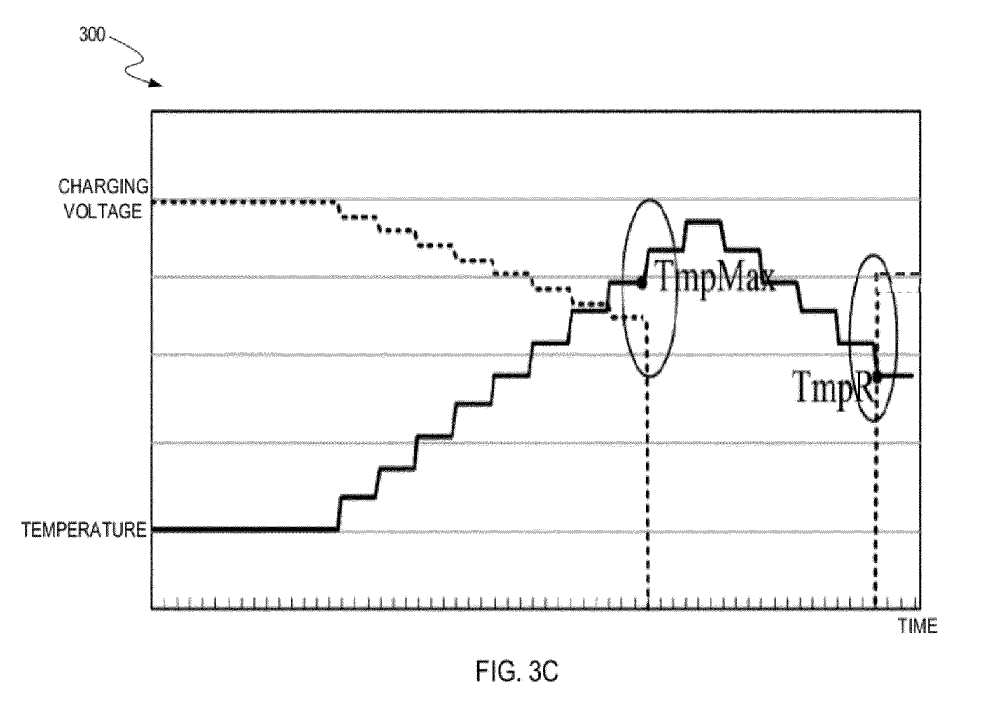

FIG. 3A illustrates an example of a relationship between the temperature of the battery and the charging voltage of the charger, in accordance with the first embodiment of the present invention. In the example of FIG. 3A, the charger operates in a constant-voltage charging stage. FIG. 3A shows the temperature of the battery represented by the solid curve and the charging voltage represented by the dotted curve. The circled portion represents the circumstance when the charging voltage of the charger is adjusted based on the temperature of the battery. As shown in FIG. 3A, at the beginning of the constant-voltage charging stage, the temperature of the battery and the charging voltage of the charger are substantially constant. When the temperature of the battery increases, the charging voltage of the charger decreases. When the temperature of the battery decreases, the charging voltage of the charger increases.

In one embodiment, during the constant-voltage charging stage, when the monitoring information indicates that the temperature of the battery increases but is less than the predetermined maximum charging temperature, the battery charging management apparatus decreases the charging voltage of the charger by a decrement corresponding to an increment of the temperature of the battery. The decrement of the charging voltage can be set based on a time interval, and can also be set based on a linear relationship between the temperature of the battery and the charging voltage of the charger. In the example of FIG. 3A, the charging voltage decreases in the shape of a ladder with the temperature of the battery increasing in the shape of a ladder.

In addition, in order to sufficiently charge the battery, after the decreasing of the charging voltage, if the monitoring information indicates that the temperature of the battery decreases, the battery charging management apparatus increases the charging voltage by an increment corresponding to a decrement of the temperature. As shown in FIG. 3A, the temperature of the battery decreases in the shape of a ladder after the decreasing of the charging voltage, and the charging voltage increases in the shape of a ladder accordingly.

FIG. 3B illustrates an example of a relationship between the temperature of the battery and the charging current of the charger, in accordance with the first embodiment of the present invention. In the example of FIG. 3B, the charger operates in a constant-current charging stage. FIG. 3B shows the temperature of the battery represented by the solid curve and the charging current represented by the dotted curve. The circled portion shows the circumstance when the charging current of the charger is adjusted based on the temperature of the battery.

In one embodiment, during the constant-current charging stage, when the monitoring information indicates that the temperature of the battery increases to a predetermined temperature but is less than the predetermined maximum charging temperature, the battery charging management apparatus decreases the charging current of the charger to a predetermined current level corresponding to the predetermined temperature. The predetermined current level can be determined based on the types of the charger and the battery. As shown in FIG. 3B, the predetermined temperature includes a first predetermined temperature Tmp1 and a second predetermined temperature Tmp2 for illustrative purposes. More specifically, when the temperature of the battery increases to the first temperature Tmp1, the battery charging management apparatus decreases the charging current of the charger to a first current level; and when the temperature of the battery increases to the second temperature Tmp2, the battery charging management apparatus further decreases the charging current of the charger to a second current level. In the example of FIG. 3B, the first predetermined temperature Tmp1 and the second predetermined temperature Tmp2 are disclosed for illustrative purposes only. In another embodiment, any number of predetermined temperature can be set for controlling the charging current of the charger.

When the temperature of the battery is greater than the predetermined maximum charging temperature, if the charger continues to charge the battery, it may cause thermal runway phenomena in the battery and damage the battery. Thus, the charger terminates charging the battery and performs over-temperature protection for the battery. FIG. 3C illustrates an example of a relationship between the temperature of the battery and the charging voltage of the charger, associated with an over-temperature charging protection process, in accordance with the first embodiment of the present invention. FIG. 3C shows the temperature of the battery represented by the solid curve and the charging voltage represented by the dotted curve. If the monitoring information indicates that the temperature of the battery is greater than or equal to the predetermined maximum charging temperature of the battery, the battery charging management apparatus controls the charger to terminate charging the battery.

More specifically, in one embodiment, when the temperature of the battery reaches or exceeds the predetermined maximum charging temperature, the battery charging management apparatus controls the charger to terminate charging the battery. If the temperature decreases to a level, e.g., a predetermined restarting charging temperature threshold, that is less than the predetermined maximum charging temperature, the battery charging management apparatus controls the charger to restart charging the battery. As shown in FIG. 3C, when the temperature reaches or exceeds a predetermined maximum charging temperature TmpMax, the battery charging management apparatus controls the charger to terminate charging the battery, and thus the charging voltage decreases to zero volts. When the temperature decreases to a predetermined restarting charging temperature threshold TmpR, the battery charging management apparatus restarts the charger to charge the battery, and the charging voltage of the charger has a level that is greater than zero. Although not shown in FIG. 3C, it is understood that when the charger terminates charging the battery, the charger also terminates generating the output current, and when the charger restarts charging the battery, the output current of the charger is generated again.

Advantageously, in the first embodiment shown in FIG. 3A, FIG. 3B and FIG. 3C, by directly controlling at least one of the charging voltage and the charging current based on the temperature of the battery, the thermal runway phenomena in the battery is avoided, thereby extending the life of the battery.

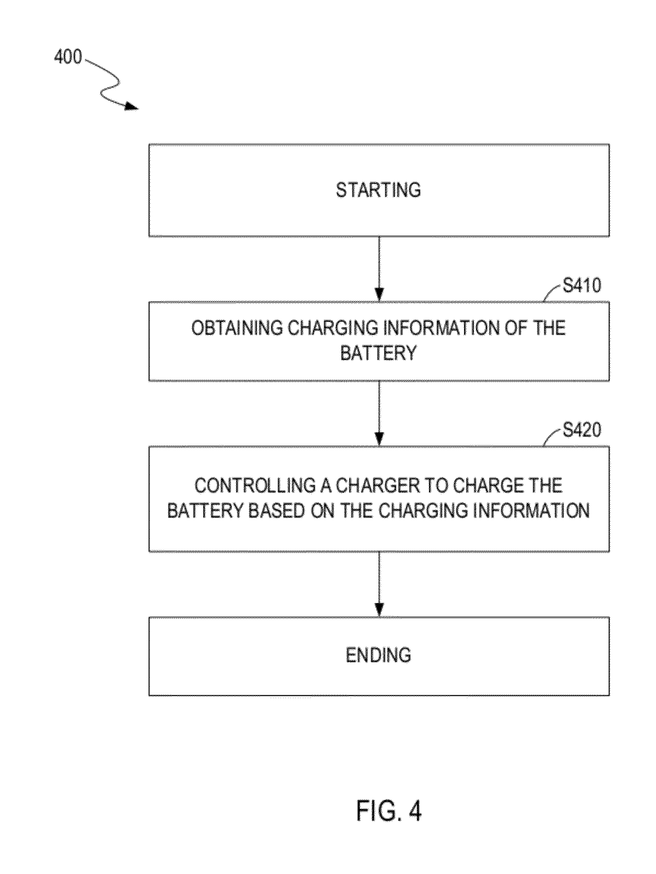

Besides controlling the charger to charge the battery based on the parameter information of the battery, the present invention can control the charger to charge the battery based on charging information of the charger, e.g., an output current of the charger. FIG. 4 illustrates a flowchart of an example of a method for managing charging of the battery based on charging information of the charger, in accordance with one embodiment of the present invention. Although specific steps are disclosed in FIG. 4, such steps are examples. That is, the present invention is well suited to perform various other steps or variations of the steps recited in FIG. 4.

In step S410, during the charging process, the battery charging management apparatus obtains the charging information of the charger. The charging information can be provided by the charger or the aforementioned battery management system. In step S420, the battery charging management apparatus controls the charger to charge the battery based on the charging information, so that the operation of the charger conforms to the charging rule corresponding to the charging process.

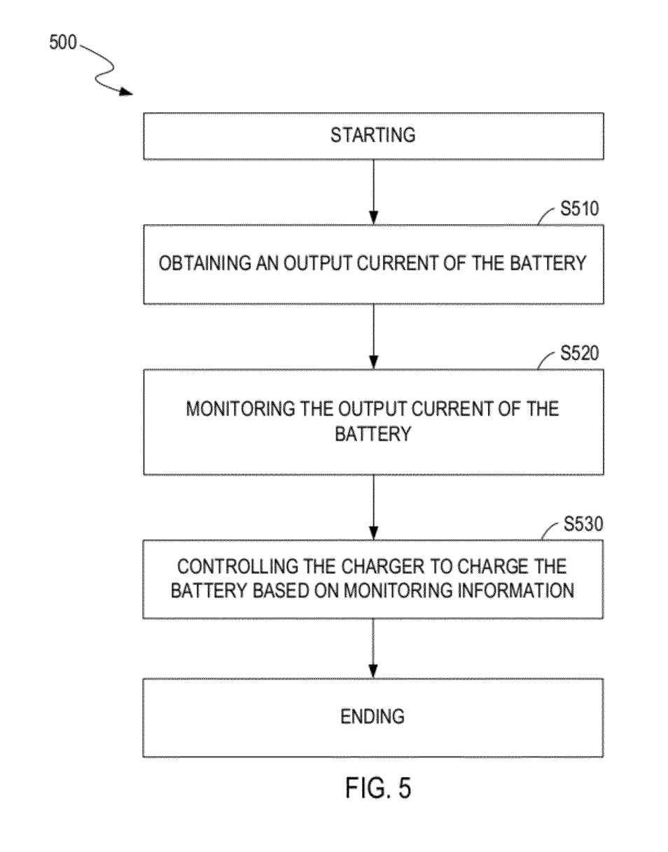

By way of example, FIG. 5 illustrates a flowchart of a method for managing charging of the battery, in accordance with a second embodiment of the present invention. Although specific steps are disclosed in FIG. 5, such steps are examples. That is, the present invention is well suited to perform various other steps or variations of the steps recited in FIG. 5. In the example of FIG. 5, the charging information includes an output current of the charger.

In step S510, the output current of the charger is obtained, e.g., by the charger, the battery management system, or the battery charging management apparatus. In step S520, the battery charging management apparatus monitors the output current of the charger to obtain monitoring information. In step S530, the battery charging management apparatus controls the charger to charge the battery based on the monitoring information.

By way of example, when the monitoring information indicates that the output current is in an abnormal condition, the battery charging management apparatus adjusts the charging voltage of the charger, so that the output current conforms to the charging rule corresponding to the charging process.

More specifically, the abnormal condition includes, but is not limited to, a) increasing of the output current of the charger during the constant-voltage charging stage, and b) the duration during which the output current and output voltage of the charger remain substantially constant in the constant-current charging stage exceeding a predetermined time period.

By monitoring the output current, the battery charging management apparatus adjusts the charging voltage of the charger if the output current is in the abnormal condition, so as to timely avoid thermal runway phenomena in the battery, thereby extending the life of the battery.

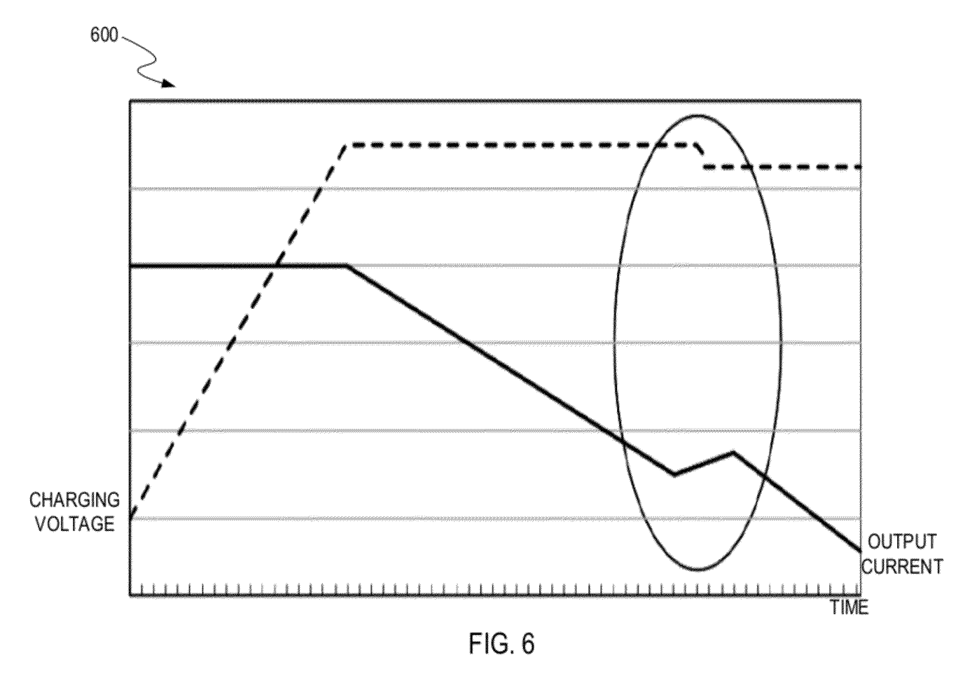

FIG. 6 illustrates an example of a relationship between the output current of the charger and the charging voltage of the charger, in accordance with the second embodiment of the present invention. FIG. 6 shows the charging voltage represented by the dotted curve and the output current of the charger represented by the solid curve. The circled portion shows the circumstance when the output current is in an abnormal condition, e.g., the output current increases in the constant-voltage charging stage. When the output current is in the abnormal condition, the battery charging management apparatus adjusts the charging voltage of the charger, such that the charging voltage decreases by a certain amount. The battery is charged based on the adjusted charging voltage, so that the output current decreases, and that the charger charges the battery conforming to the charging rule.

As such, controlling the output current of the charger to be conformed to the charging rule can avoid an abnormal increase of the temperature of the battery caused by the increase of the current, and also reduce the probability of occurrence of the thermal runaway phenomena.

Some abnormal conditions may not be detected using the parameter information of the battery and the charging information of the charger. By way of example, during the constant-current charging stage, the output current of the charger remains substantially constant, and the output voltage of the charger increases. However, after the output current remains substantially constant for a relatively long time, if the output voltage is still less than the charging voltage required by the charger in the constant-voltage charging stage, the charging process may not enter the constant-voltage charging stage from the constant-current charging stage. Advantageously, according to a third embodiment of the present invention, a charging time for the battery is monitored, so as to avoid charging the battery for too long during a charging stage that is caused by an abnormal condition, and to avoid thermal runaway phenomena in the battery.

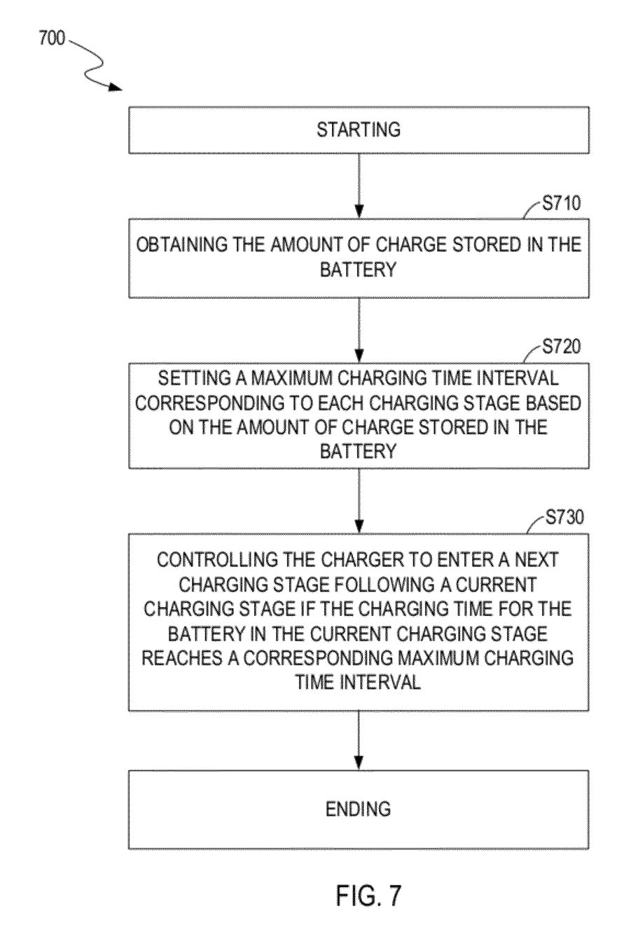

FIG. 7 illustrates a flowchart of an example of a method for managing charging of the battery based on the mount of charge stored in the battery, in accordance with the third embodiment of the present invention. Although specific steps are disclosed in FIG. 7, such steps are examples. That is, the present invention is well suited to perform various other steps or variations of the steps recited in FIG. 7.

In step S710, the amount of charge stored in the battery is obtained, e.g., by the charger, the battery management system, or the battery charging management apparatus.

In step S720, a maximum charging time interval corresponding to each charging stage during a charging process performed by the charger for the battery is set based on the amount of charge stored in the battery.

In step S730, if the charging time for the battery in a current charging stage reaches a corresponding maximum charging time interval, the battery charging management apparatus controls the charger to enter a next charging stage following the current charging stage.

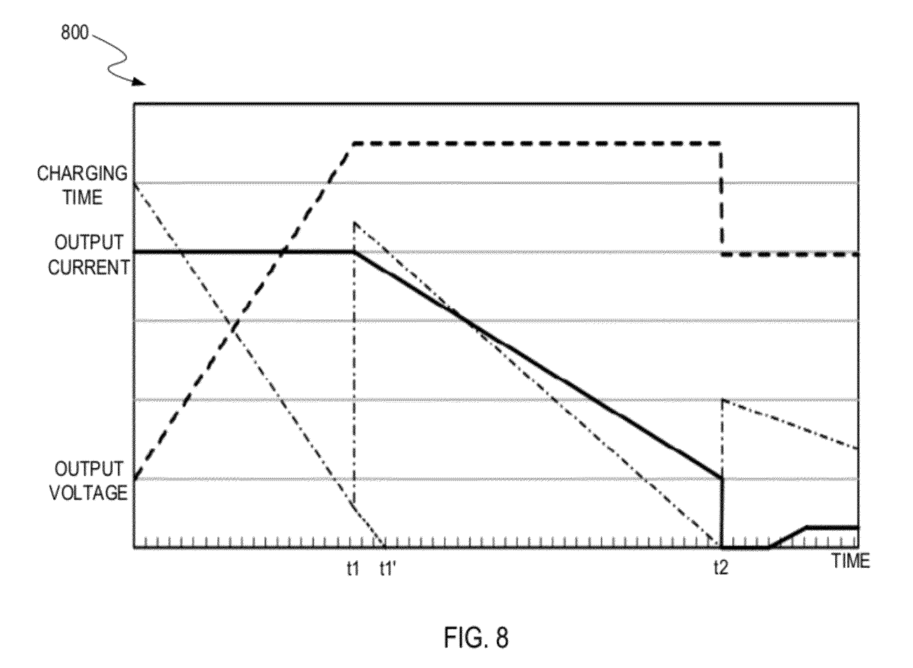

FIG. 8 illustrates an example of a relationship between a charging time, the output current of the charger, and the output voltage of the charger, in accordance with the third embodiment of the present invention. FIG. 8 shows the output current of the charger represented by the solid curve, the output voltage of the charger represented by the dotted curve, and the charging time of the charger represented by the dash-dotted curve in respective charging stage.

In the example of FIG. 8, the charger operates in a constant-current charging stage before time t1, operates in a constant-voltage charging stage between times t1 and t2, and operates in a floating charge stage after time t2. A maximum charging time interval corresponding to the constant-current charging stage is set to be t1′, and a maximum charging time interval corresponding to the constant-voltage charging stage is set to be t2−t1. As shown in FIG. 8, before the time t1, the charger is in the constant-current charging stage, and the output voltage of the charger increases. The output voltage of the charger reaches a charging voltage V1 required in the constant-voltage charging stage before the charging time for the battery reaches the maximum charging time interval t1′, and therefore the charger enters the constant-voltage charging stage, and the output current of the charger decreases. At time t2, the charging time for the battery in the constant-voltage charging stage reaches the maximum charging time interval t2−t1. However, the output current of the charger is still greater than a predetermined current (not shown in the FIG. 8) that causes the charger to enter a next charging stage, e.g., the floating charging stage. If the charger is not interfered, the charger continues to work in the constant-voltage charging stage. Thus, the battery charging management apparatus controls the charger to enter the floating charging stage from the constant-voltage charging stage by reducing the charging voltage. In the floating charging stage, e.g., after time t2, the charger charges the battery at a charging voltage V2 that is less than the charging voltage V1 in the constant-voltage charging stage, to compensate the lost energy due to the battery's self-discharging.

In the example of FIG. 8, the charger enters a next charging stage, e.g., the constant-voltage charging stage, before the maximum charging time interval of the constant-current charging stage t1′ expires. In another embodiment, if the output voltage of the charger is still less than the charging voltage V1 required in the constant-voltage charging stage when the maximum charging time interval t1′ of the constant-current charging stage expires, the battery charging management apparatus controls the charger to enter the constant-voltage charging stage, and the charger charges the battery at the charging voltage V1.

Advantageously, by monitoring the charging time for the battery in each charging stage, the present invention can prevent the charger from charging the battery for too long in a charging stage, e.g., caused by an abnormal condition in the output current of the charger, and therefore avoid the thermal runaway phenomena in the battery.

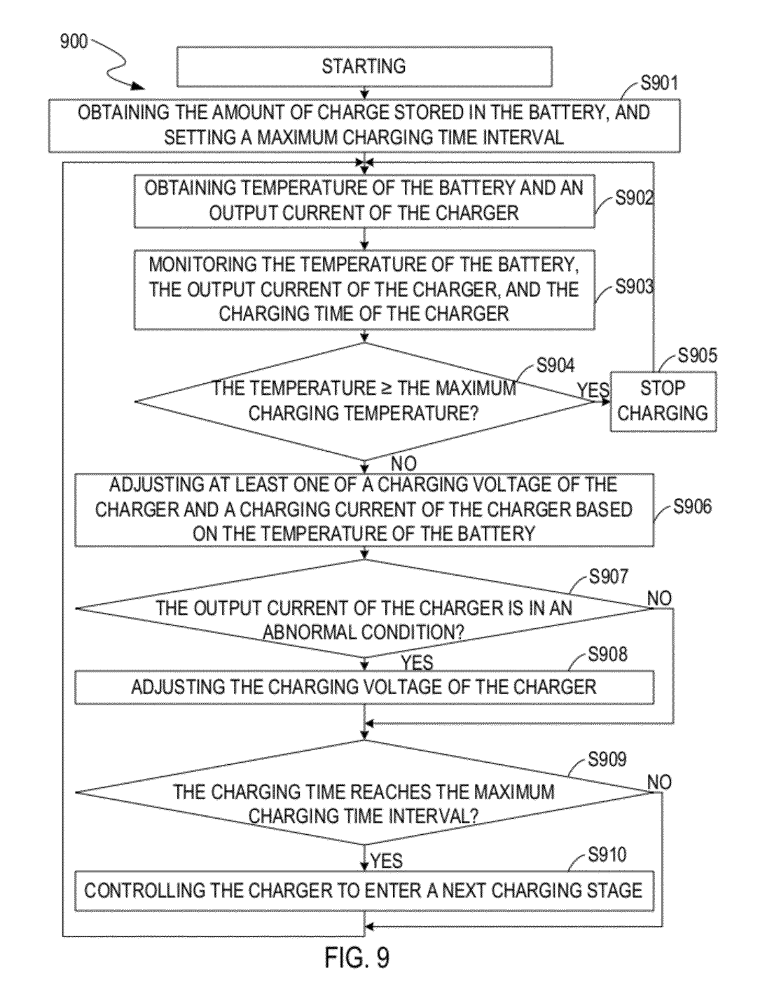

The methods mentioned above can be performed alone or in combination with one another to reduce the thermal runaway phenomena in the battery. FIG. 9 illustrates a flowchart of an example of a method for managing charging of the battery, in accordance with one embodiment of the present invention. Although specific steps are disclosed in FIG. 9, such steps are examples. That is, the present invention is well suited to perform various other steps or variations of the steps recited in FIG. 9. In the example of FIG. 9, the methods in relation to the aforementioned first, second, and third embodiments are performed in combination with one another.

In step S901, before starting charging the battery by the charger, the amount of charge stored in the battery is obtained, and the maximum charging time interval corresponding to each charging stage is preset based on the amount of charge stored in the battery. The flowchart 900 turns to step S902 following step S901.

There is a relationship between the amount of charge stored in the battery and the charging time of the charger. By way of example, in the constant-current charging stage, the amount of charge stored in the battery is proportional to the charging time of the charger. In the constant-voltage charging stage, the amount of charge stored in the battery increases as the charging time of the charger increases. Thus, the maximum charging time interval corresponding to each charging stage during the charging process can be set based on the amount of charge stored in the battery.

In step S902, during the charging process, the temperature of the battery and the output current of the charger are obtained, e.g., by the charger, the battery management system, or the battery charging management apparatus. The flowchart 900 turns to step S903 following step S902. In the example of FIG. 9, the parameter information of the battery includes the temperature of the battery, and the charging information of the charger includes the output current of the charger.

In step S903, the battery charging management apparatus monitors the temperature of the battery, the output current of the charger, and the charging time of the charger to obtain monitoring information, and then the flowchart 900 turns to step S904. The battery charging management apparatus controls the charger to charge the battery based on the monitoring information in the following steps.

In step S904, the battery charging management apparatus determines whether the temperature of the battery is greater than or equal to a predetermined maximum charging temperature. If the temperature of the battery is greater than or equal to the predetermined maximum charging temperature, the flowchart 900 turns to step S905; and if the temperature of the battery is less than the predetermined maximum charging temperature, the flowchart 900 turns to step S906.

In step S905, the battery charging management apparatus controls the charger to terminate charging the battery.

In step S906, the battery charging management apparatus adjusts at least one of the charging voltage of the charger and the charging current of the charger based on the temperature of the battery. By way of example, during the constant-voltage charging stage, the battery charging management apparatus decreases the charging voltage of the charger if the temperature of the battery increases, and increases the charging voltage of the charger if the temperature of the battery decreases. By way of another example, during the constant-current charging stage, the battery charging management apparatus decreases the charging current if the temperature of the battery increases.

In step S907, the battery charging management apparatus determines whether the output current of the charger is in an abnormal condition. The abnormal condition includes, but is not limited to, a) increasing of the output current of the charger during the constant-voltage charging stage, and b) the duration during which the output current and output voltage of the charger remain substantially constant in the constant-current charging stage exceeding a predetermined time period. If the abnormal condition occurs, the flowchart 900 turns to step S908; otherwise, the flowchart 900 turns to step S909.

In step S908, the battery charging management apparatus adjusts the charging voltage of the charger, so that the output current of the charger conforms to the charging rule. By way of example, if the output current of the charger increases abnormally in the constant-voltage charging stage, the battery charging management apparatus decreases the charging voltage of the charger by a certain amount, and the charger uses the decreased charging voltage to continue the constant-voltage charging of the battery. As such, the output current is reduced to be conformed to the charging rule.

In step S909, the battery charging management apparatus determines whether the charging time in a current charging stage reaches the maximum charging time interval corresponding to the current charging stage. If the charging time reaches the maximum charging time interval, the flowchart 900 turns to step S910; otherwise, the flowchart 900 turns to step S902.

In step S910, the battery charging management apparatus controls the charger to enter a next charging stage following the current charging stage, and the flowchart 900 turns to step S902, so that the charger charges the battery in the next charging stage.

FIG. 10 illustrates a block diagram of an example of a battery charging management apparatus 1000, in accordance with one embodiment of the present invention. As shown in FIG. 10, the battery charging management apparatus 1000 includes an information obtaining unit 1010 and a controlling unit 1020. The information obtaining unit 1010 is used to obtain parameter information of a battery during a charging process performed by the charger for the battery. The controlling unit 1020 is used to control the charger to charge the battery based on the parameter information of the battery obtained by the information obtaining unit 1010, so that the operation of the charger conforms to the charging rule corresponding to the charging process.

The controlling of the charger can avoid an abnormal increase of the temperature of the battery that is caused by anomalies produced during the charging process, then avoid thermal runway phenomena in the battery, thereby extending the life of the battery.

Furthermore, the information obtaining unit 1010 can obtain the parameter information of the battery using the charger or the battery management system. In one embodiment, the parameter information of the battery includes temperature of the battery. The controlling unit 1020 monitors the temperature of the battery obtained by the information obtaining unit 1010 to obtain monitoring information, and controls the charger to charge the battery based on the monitoring information. If the monitoring information indicates that the temperature is greater than or equal to a predetermined maximum charging temperature, the controlling unit 1020 controls the charger to terminate charging the battery; otherwise, the controlling unit 1020 adjusts at least one of the charging voltage and charging current of the charger based on the battery temperature.

In one embodiment, the information obtaining unit 1010 further obtains charging information of the charger during the charging process. The controlling unit 1020 controls the charger to charge the battery based on the charging information obtained by the information obtaining unit 1010, so that the operation of the charger conforms to the charging rule corresponding to the charging process.

In one embodiment, the charging information includes the output current of the charger. The controlling unit 1020 monitors the output current of the charger obtained by the information obtaining unit 1010, obtains monitoring information, and controls the charger to charge the battery based on the monitoring information. If the monitoring information indicates that the output current of the charger is in an abnormal condition, the controlling unit 1020 adjusts the charging voltage of the charger, so that the output current of the charger conforms to the charging rule corresponding to the charging process.

In one embodiment, the information obtaining unit 1010 further obtains information for the amount of charge stored in the battery. The controlling unit 1020 further sets a maximum charging time interval corresponding to each charging stage during the charging process based on the amount of charge stored in the battery. If the charging time for the battery in a current charging stage reaches the maximum charging time interval corresponding to the current charging stage, the controlling unit 1020 controls the charger to enter a next charging stage following the current charging stage.

Components, e.g., the information obtaining unit 1010 and the controlling unit 1020, of the battery charging management apparatus 1000 can operate according to the description described in relation to FIG. 1, FIG. 2, FIG. 3A, FIG. 3B, FIG. 3C, FIG. 4, FIG. 5, FIG. 6, FIG. 7, FIG. 8 and FIG. 9.

The battery charging management apparatus 1000 can include hardware or firmware, e.g., MCU (microcontroller) or SCM (single chip microcomputer). In one embodiment, the battery charging management apparatus 1000 can be separated from the charger and the battery management system, and can communicate with the battery management system and/or the charger, e.g., via a communication bus. In another embodiment, the battery charging management apparatus 1000 can reside on the battery management system or the charger. For example, the battery charging management apparatus 1000 can be inside the MCU or SCM of the battery management system or the charger, and can perform the aforementioned methods for managing the battery.

FIG. 11 illustrates a block diagram of an example of a charger 1100, in accordance with one embodiment of the present invention. The charger 1100 includes a battery charging management apparatus 1110. The battery charging management apparatus 1110 can be the battery charging management apparatus 1000 in FIG. 10.

FIG. 12 illustrates a block diagram of an example of a battery management system 1200 with a charger 1220, in accordance with one embodiment of the present invention. The battery management system 1200 includes the battery charging management apparatus 1210. The battery charging management apparatus 1210 can be the battery charging management apparatus 1000 in FIG. 10. The battery charging management apparatus 1210 sends a controlling signal to the charger 1220, so that the charger 1220 performs the steps of the aforementioned methods for managing the battery.

While the foregoing description and drawings represent embodiments of the present invention, it will be understood that various additions, modifications and substitutions may be made therein without departing from the spirit and scope of the principles of the present invention as defined in the accompanying claims. One skilled in the art will appreciate that the invention may be used with many modifications of form, structure, arrangement, proportions, materials, elements, and components and otherwise, used in the practice of the invention, which are particularly adapted to specific environments and operative requirements without departing from the principles of the present invention. The presently disclosed embodiments are therefore to be considered in all respects as illustrative and not restrictive, the scope of the invention being indicated by the appended claims and their legal equivalents, and not limited to the foregoing description.

What is claimed is:

1. A method for managing charging of a battery, said method comprising:
obtaining parameter information for temperature of said battery during a charging process performed by a charger for said battery; and
controlling said charger to charge said battery based on said parameter information, so that operation of said charger conforms to a charging rule corresponding to said charging process, wherein said controlling comprises decreasing a charging signal of said charger by a predetermined decrement if said temperature increases by a predefined increment.

2. The method as claimed in claim 1, wherein said charging signal comprises a charging voltage of said charger.

3. The method as claimed in claim 1, wherein said charging signal comprises a charging current of said charger.

4. The method as claimed in claim 1, wherein said controlling further comprises:
controlling said charger to terminate charging said battery if said temperature of said battery is greater than a predetermined maximum charging temperature; and
decreasing said charging signal of said charger by said predetermined decrement in response to said predefined increment if said temperature of said battery is less than said predetermined maximum charging temperature.

5. The method as claimed in claim 1, further comprising:
monitoring an output current of said charger; and
controlling a charging voltage of said charger based on said output current.

6. The method as claimed in claim 5, wherein said controlling said charging voltage comprises:
adjusting a charging voltage of said charger if said output current of said charger is in an abnormal condition, so that said output current of said charger conforms to said charging rule.

7. The method as claimed in claim 6, wherein said abnormal condition comprises an increase of said output current when said charger operates in a constant-voltage charging stage.

8. The method as claimed in claim 6, wherein said adjusting comprises decreasing said charging voltage.

9. The method as claimed in claim 1, further comprising:
obtaining amount of charge stored in said battery;
setting a maximum charging time interval of said charger corresponding to a first charging stage in said charging process based on said amount of charge stored in said battery; and
controlling said charger to enter a second charging stage following said first charging stage if a charging time of said battery in said first charging stage reaches said maximum charging time interval corresponding to said first charging stage.

10. A battery charging management apparatus comprising:
an information obtaining unit that obtains parameter information for temperature of a battery during a charging process performed by a charger for said battery; and
a controlling unit, coupled to said information obtaining unit, that controls said charger to charge said battery based on said parameter information of said battery, so that operation of said charger conforms to a charging rule corresponding to said charging process, wherein said controlling unit decreases a charging signal of said charger by a predetermined decrement if said temperature increases by a predefined increment.

11. The battery charging management apparatus as claimed in claim 10, wherein said charging signal comprises a charging voltage of said charger.

12. The battery charging management apparatus as claimed in claim 10, wherein said charging signal comprises a charging current of said charger.

13. The battery charging management apparatus as claimed in claim 10, wherein said controlling unit controls said charger to terminate charging said battery if said temperature of said battery is greater than a predetermined maximum charging temperature, and wherein said controlling unit decreases said charging signal of said charger by said predetermined decrement in response to said predefined increment if said temperature of said battery is less than said predetermined maximum charging temperature.

14. The battery charging management apparatus as claimed in claim 10, wherein said controlling unit monitors an output current of said charger and controls a charging voltage of said charger based on said output current.

15. The battery charging management apparatus as claimed in claim 14, wherein said controlling unit decreases said charging voltage if said output current of said charger is in an abnormal condition, so that said output current of said charger conforms to said charging rule.

16. The battery charging management apparatus as claimed in claim 10, wherein said information obtaining unit obtains amount of charge stored in said battery, wherein said controlling unit sets a maximum charging time interval of said charger corresponding to a first charging stage in said charging process, and wherein said controlling unit controls said charger to enter a second charging stage following said first charging stage if a charging time of said battery in said first charging stage reaches said maximum charging time interval corresponding to said first charging stage.

17. A charger for charging a battery, said charger comprising:
an apparatus that controls operation of said charger to be conformed to a charging rule of said charger, said apparatus comprising:
an information obtaining unit that obtains information for temperature of said battery; and
a controlling unit, coupled to said information obtaining unit, that controls said operation of said charger to be conformed to said charging rule by controlling said charger to charge said battery based on said information of said battery, wherein said controlling unit decreases a charging signal of said charger by a predetermined decrement if said temperature increases by a predefined increment.

18. The charger as claimed in claim 17, wherein during a first charging stage, if said temperature of said battery is less than a predetermined maximum charging temperature, then said controlling unit decreases a charging current of said charger if said temperature of said battery increases, and wherein said charging signal comprises said charging current.

19. The charger as claimed in claim 18, wherein during a second charging stage, if said temperature of said battery is less than said predetermined maximum charging temperature, said controlling unit decreases a charging voltage of said charger if said temperature of said battery increases, and increases said charging voltage of said charger if said temperature of said battery decreases, and wherein said charging signal comprises said charging voltage.

20. The charger as claimed in claim 19, wherein during said first and second charging stages, if said temperature of said battery is greater than said predetermined maximum charging temperature, said controlling unit controls said charger to terminate charging of said battery.
